(19) United States
(12) Patent Application Publication
(10) Pub. No.: US 2019/0138049 A1
(43) Pub. Date: May 9, 2019

(54) Virtual Reality Headset Frame

(71) Applicant: Lee Serota, Oswego, IL (US)

(72) Inventor: Lee Serota, Oswego, IL (US)

(21) Appl. No.: 16/236,022

(22) Filed: Dec. 28, 2018

Related U.S. Application Data
(63) Continuation-in-part of application No. 15/823,979, filed on Nov. 28, 2017, now Pat. No. 10,203,723.
(60) Provisional application No. 62/520,208, filed on Jun. 15, 2017.
(60) Provisional application No. 62/669,843, filed on May 10, 2018.
(60) Provisional application No. 62/723,223, filed on Aug. 27, 2018.

(51) Int. Cl. G06F 1/16; A42B 3/04; A42B 1/02; A42B 1/24; A42B 3/30

(52) U.S. Cl. CPC G06F 1/163; A42B 3/042; A42B 3/306; A42B 1/247; A42B 1/245; A42B 1/02

(57) ABSTRACT

A virtual reality (VR) headset frame is configured to receive and support a wireless audio headset and a VR display. A primary headband frame is connected between two ear portion frames, forming the general structure. A VR display may be attached to a pair of display support arms, which are connected to a pair of locking rings. The locking rings are rotatably engaged within the ear portion frames. The locking rings are rotatable relative to the ear portion frames, enabling the headband frame to be selectively engaged into one of a plurality of orientations while in use on a user's head. Multiple headbands may be utilized to optimize weight distribution.

The current application is a continuation-in-part (CIP) application of a U.S. non-provisional application Ser. No. 15/823,979 filed on Nov. 28, 2017. The U.S. non-provisional application Ser. No. 15/823,797 claims a priority to a U.S. provisional application Ser. No. 62/520,208 filed on Jun. 15, 2017.

The current application also claims a priority to a U.S. provisional application Ser. No. 62/669,843 filed on May 10, 2018.

The current application also claims a priority to a U.S. provisional application Ser. No. 62/723,223 filed on Aug. 27, 2018.

### FIELD OF THE INVENTION

The present invention relates generally to wearable electronics. More particularly, the present invention relates to virtual reality headsets.

### BACKGROUND OF THE INVENTION

Virtual reality technology has seen rapid improvement in recent years. The most ubiquitous piece of VR technology is the headset. However, current headsets are still very clunky and require many wires to connect various peripherals such as headphones. It is therefore an objective of the present invention to introduce a virtual reality headset which incorporates an LED wireless Bluetooth headset to allow for wireless connectivity. Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention

### BRIEF DESCRIPTION OF THE DRAWINGS

FIG. 1 is a perspective view of the present invention according to one embodiment.

FIG. 2 is a perspective view of the present invention with an attached wireless audio headset and VR display.

FIG. 3 is a front view of the present invention according to one embodiment.

FIG. 4 is a rear view of the present invention according to one embodiment.

FIG. 5 is a right view of the present invention according to one embodiment in the 90 degree orientation.

FIG. 6 is a right view of the present invention according to one embodiment in the 135 degree orientation.

FIG. 7 is a right view of the present invention according to one embodiment in the 180 degree orientation.

FIG. 8 is a top view of the present invention according to one embodiment.

FIG. 9 is a bottom view of the present invention according to one embodiment.

FIG. 10 is a perspective view of one of the locking rings according to one embodiment.

FIG. 11 is a perspective view of the primary headset frame and ear portion frames according to one embodiment.

FIG. 12 is a perspective view of an embodiment comprising three headband frames.

FIG. 13 is a side view of the embodiment comprising three headband frames.

FIG. 14 is a perspective view of an embodiment comprising a helmet shape as the headband frame.

FIG. 15 is a a perspective view of an embodiment comprising a helmet shape used in conjunction with the headband frame.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

The present invention is an adjustable headset frame configured for receiving and supporting a wireless audio headset 100 and a virtual reality (VR) display 100. In some embodiments, the present invention may simply be a supporting structure for adding electronic components such as a wireless audio headset 100 and a VR display 100. In some embodiments, the present invention may comprise various internal electronic components which may be electronically paired with an insertable wireless audio headset 100 and a VR display 100.

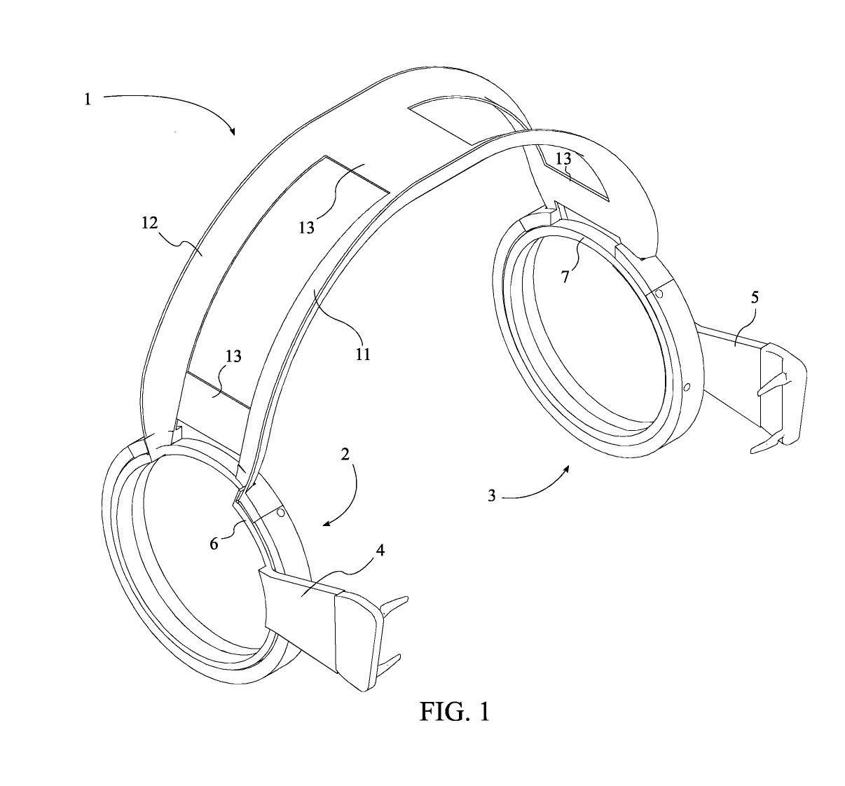

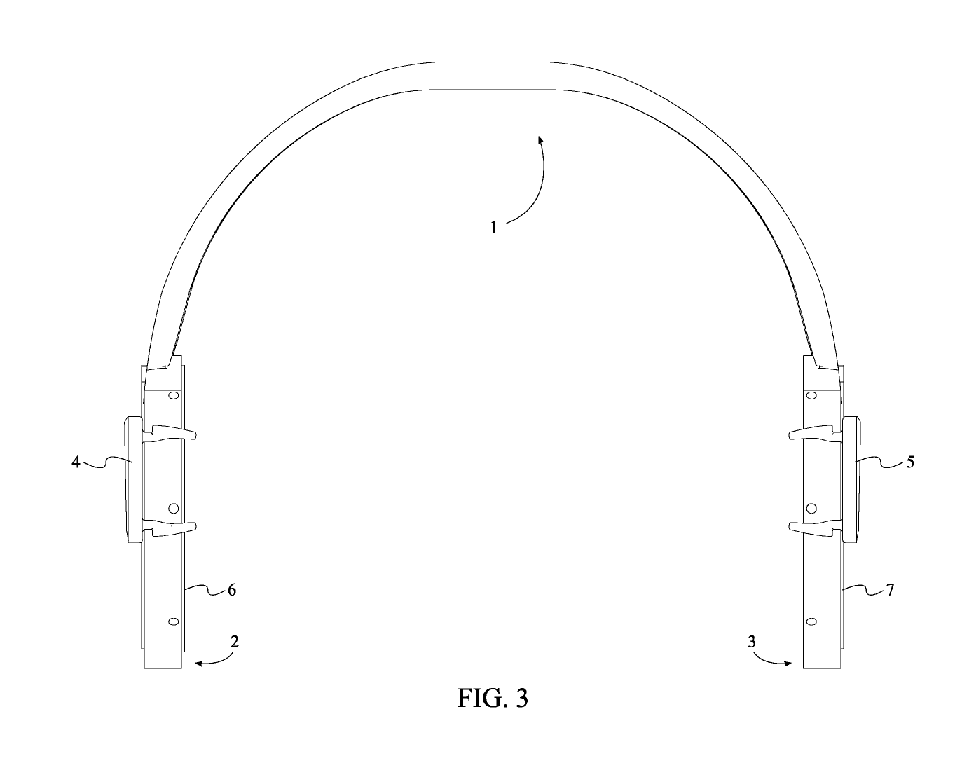

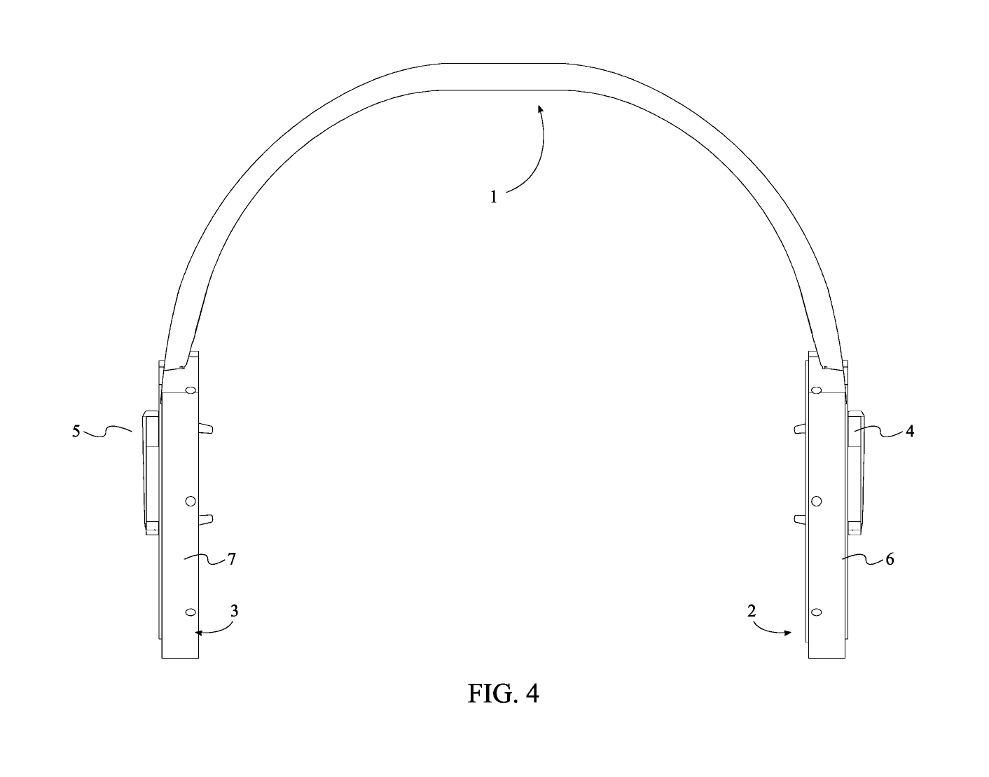

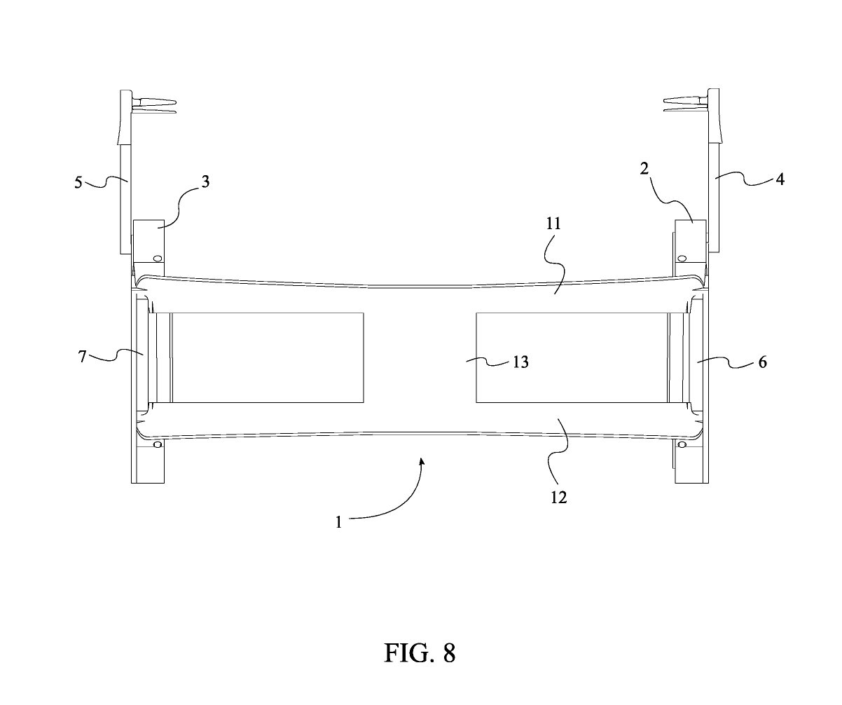

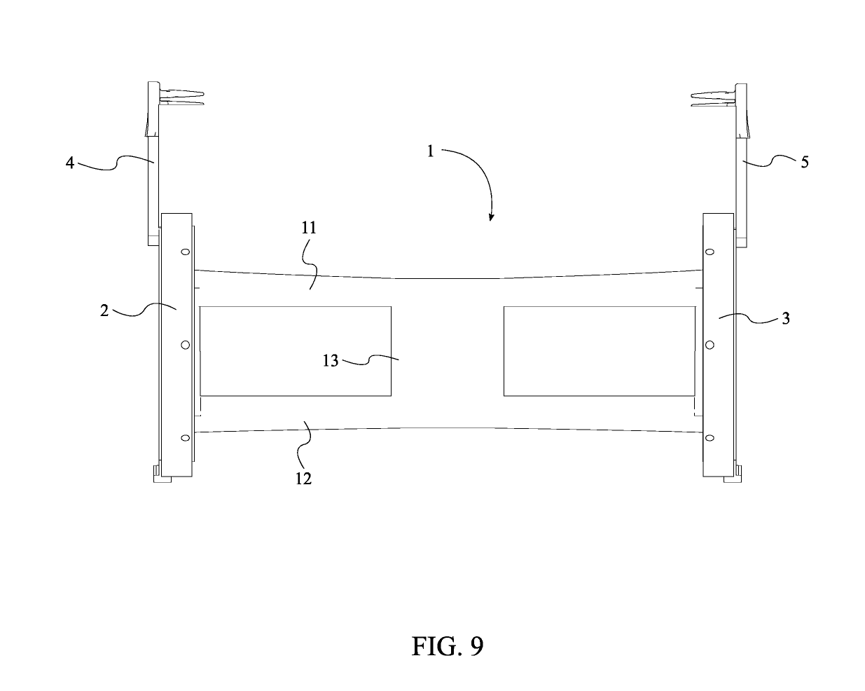

Referring to FIGS. 1-9, in general, the present invention comprises a primary headband frame 1, a first ear portion frame 2 and a second ear portion frame 3. The first ear portion frame 2 is terminally connected to the primary headband frame 1, and the second ear portion is terminally connected to the primary headband frame 1 opposite the first ear portion along the primary headband frame 1. The first ear portion frame 2 and the second ear portion frame 3 rest atop a user's ears while in use, with the primary headband frame 1 being positioned in one of a plurality of positions on the top to rear of the user's head. The first ear portion frame 2, the second ear portion frame 3, and the primary headband frame 1 are constructed and configured appropriately to receive a wireless audio headset 100. The present invention functions generally as a platform for attaching a wireless audio headset 100 and a VR display 100 to be used in conjunction to consume digital media and/or play VR games.

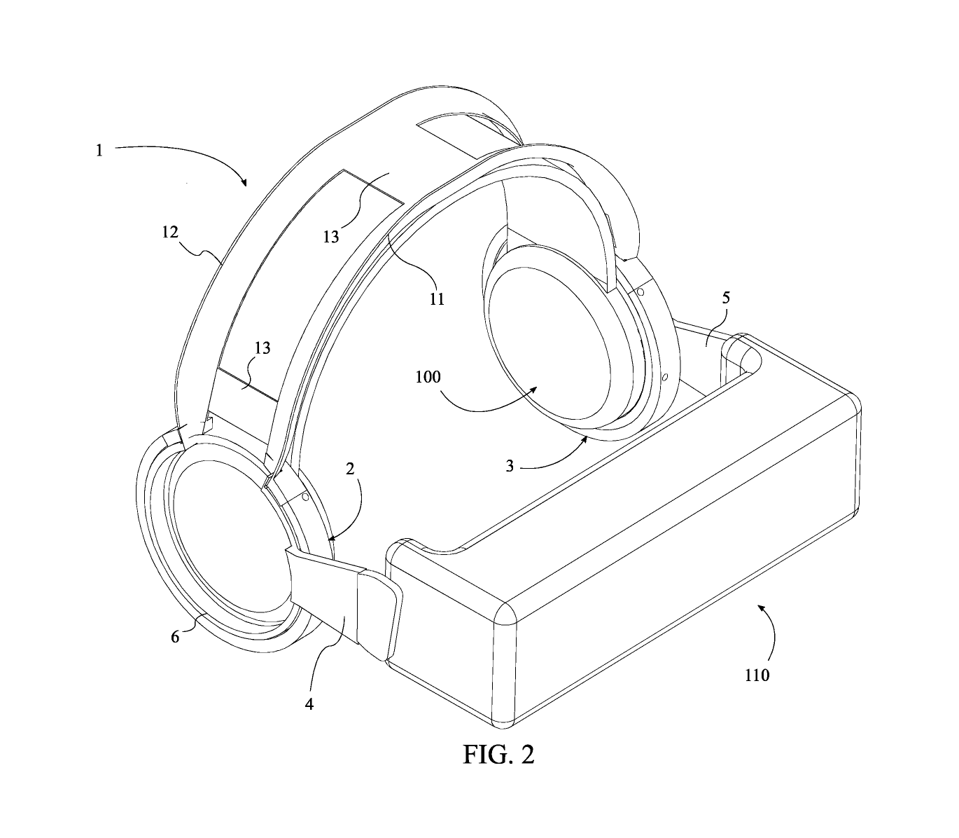

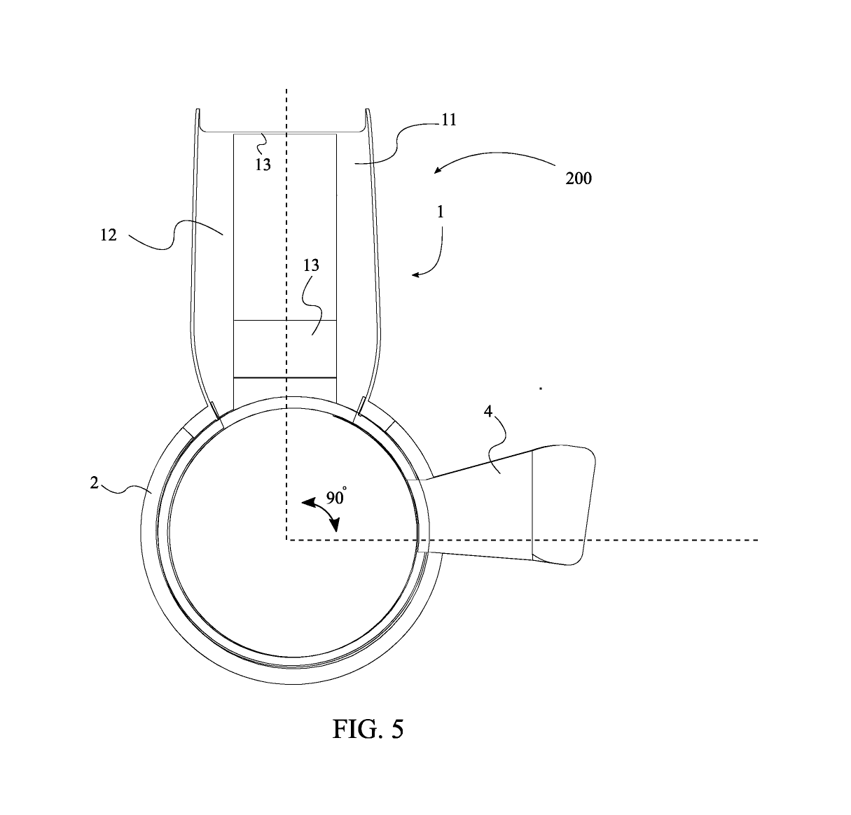

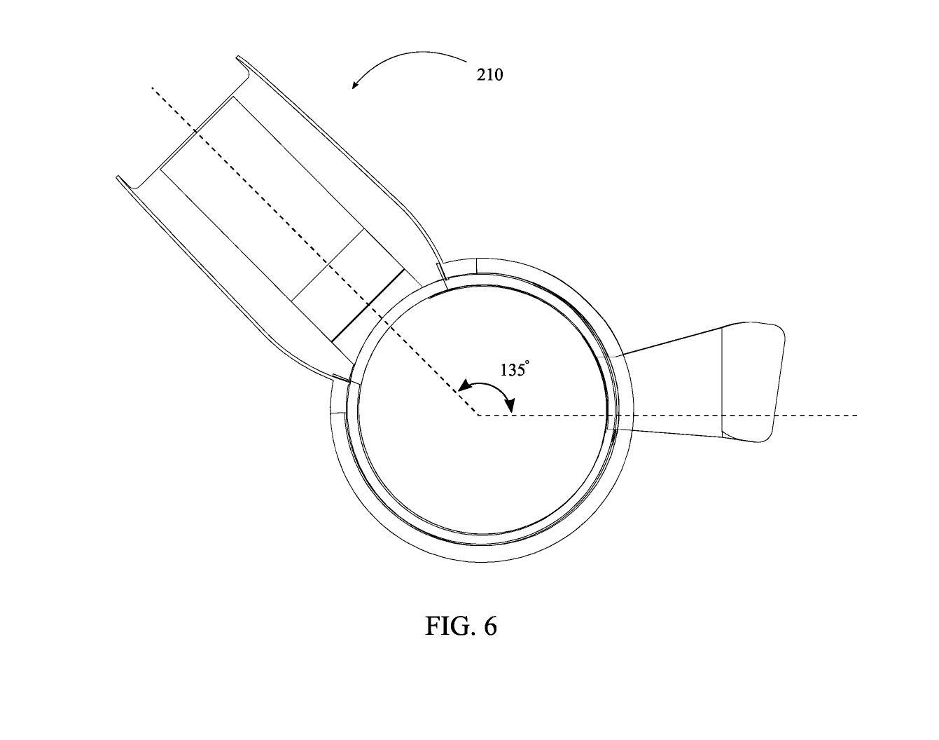

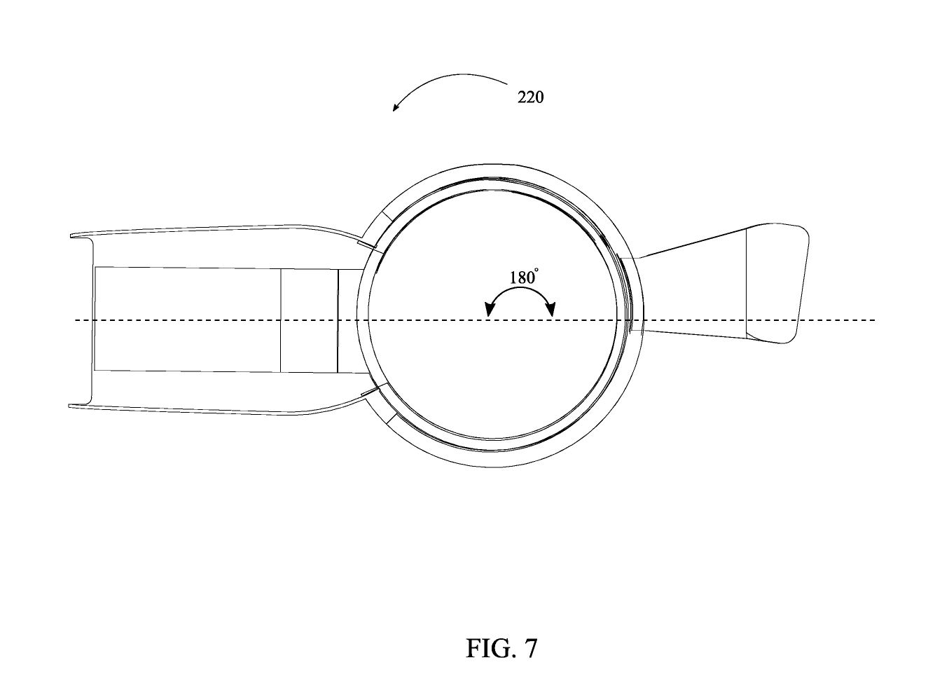

The preferred embodiment of the present invention further comprises a first display support arm 4 and a second display support arm 5. The first display support arm 4 is rotatably attached to the first ear portion frame 2. Similarly, the second display support arm 5 is rotatably attached to the second ear portion frame 3. The first display support arm 4 and the second display support arm 5 are configured to support a VR display 100 in front of the user's eyes while wearing the present invention, as shown in FIG. 2. Furthermore, the first display support arm 4 and the second display support arm 5 are configured to be selectably engaged into one of a plurality of orientations with respect to the primary headband frame 1. Thus, while wearing the present invention, the user is able to position the primary headband frame 1, and therefore any wireless audio headset 100 positioned into the present invention, at any desired angle, such as, but not limited to, a 90 degree orientation 200 as seen in FIG. 5 with respect to the first display support arm 4 and the second display support arm 5 atop the user's head, a 135 degree orientation 210 on the upper rear portion of the user's head as seen in FIG. 6, or a 180 degree orientation 220 at the rear of the user's head as seen in FIG. 7.

In some embodiments, the primary headband frame 1 comprises a first arced portion 11 and a second arced portion 12. The first arced portion 11 and the second arced portion 12 are preferably oriented parallel to each other and are spaced apart from each other. This is a desirable configuration in order to reduce the weight of the present invention in addition to improving ergonomics. The first arced portion 11 and the second arced portion 12 are terminally connected between the first ear portion frame 2 and the second ear portion frame 3.

Further, in some embodiments, the primary headband frame 1 further comprises at least one crossmember 13. Each of the at least one crossmember 13 is terminally and perpendicularly connected between the first arced portion 11 and the second arced portion 12 in order to provide enhanced structural support to the primary headband frame 1. Each of the at least one crossmember 13 is positioned between the first ear portion frame 2 and the second ear portion frame 3 along the headband. More particularly, in some embodiments, a first crossmember is positioned adjacent to the first ear portion frame 2, a second crossmember is positioned equidistantly between the first ear portion frame 2 and the second ear portion frame 3, and a third crossmember is positioned adjacent to the second ear portion frame 3.

As previously mentioned, in the preferred embodiment of the present invention, the first display support arm 4 and the second display support arm 5 are configured to be selectably engaged into either a 90 degree orientation 200, a 135 degree orientation 210, or a 180 degree orientation 220 with respect to the primary headband frame 1. In various embodiments, the first display support arm 4 and the second display support arm 5 may be configured to be selectably engaged into any desired orientation with respect to the primary headband frame 1.

It is contemplated that many various means may be employed in the present invention to achieve the aforementioned ability of the primary headband frame 1 to rotate into various desired positions atop, behind, or in another location with respect to the user's head. However, in order to do so, the preferred embodiment further comprises a first locking ring 6 and a second locking ring 7. The first locking ring 6 is rotatably attached within the first ear portion frame 2, and the second locking ring 7 is similarly rotatably attached within the second ear portion frame 3. The first display support arm 4 is terminally connected to the first locking ring 6, and the second display support arm 5 is terminally connected to the second locking ring 7. In some embodiments, the locking rings and display support arms may be manufactured together as a singular unit. Thus, as the first locking ring 6 and the second locking ring 7 rotate within the first ear portion frame 2 and the second ear portion frame 3, respectively, the first display support arm 4 and the second display support arm 5 rotate about the first ear portion frame 2 and the second ear portion frame 3, respectively, thus enabling the user to position the headband portion, and thus the wireless audio headset 100, at a desired angle on the user's head with respect to the VR display 100 attached to the first display support arm 4 and the second display support arm 5.

It may be understood that any desired and useful means may be utilized in the present invention in order to a) enable the user to select a desired orientation of the primary headband frame 1 with respect to any attached VR display 100, and b) lock the primary headband frame 1 in said desired orientation. In some embodiments, locking the desired orientation may be achieved simply through friction between components; for example, friction between the locking rings and ear portion frames. It is preferable, however, that the present invention comprises an angular locking mechanism in order to securely affix the headband portion into the desired orientation. The specific nature of the angular locking mechanism may vary in different embodiments according to various design requirements, feasibility, and user preference. For example, in some embodiments the angular locking mechanism may utilize one or more clips to secure the locking rings against rotation relative to the ear portion frames, or a pin and hole arrangement may be used, or a ratcheting mechanism, or similar.

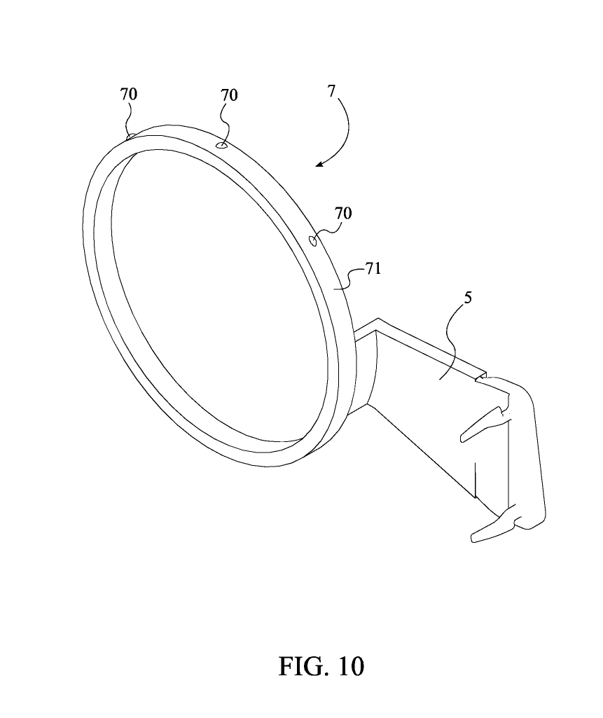

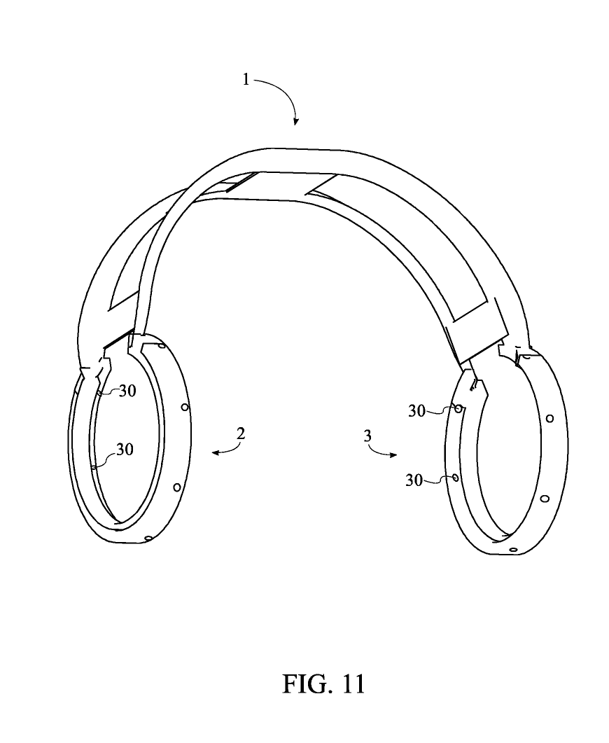

In the preferred embodiment, the angular locking mechanism utilizes a protrusion and receptacle arrangement, where protrusions located on one components may be manipulated by the user to fall into corresponding receptacles or holes on the corresponding component, temporarily affixing the two components in place. To this end, referring to FIGS. 10-11, the first locking ring 6 and the second locking ring 7 each comprise at least one primary engagement point 70, while the first ear portion frame 2 and the second ear portion frame 3 each comprise at least one secondary engagement point 30. In some embodiments, each of the at least one primary engagement point 70 may be a nub or similar protrusion, while each of the at least one secondary engagement point 30 may be a hole or receptacle, or vice versa.

Each of the at least one primary engagement point 70 is externally and peripherally distributed about the first locking ring 6 and the second locking ring 7, and each of the at least one secondary engagement point 30 is internally distributed about the first ear portion frame 2 and the second ear portion frame 3. Preferably, the primary and secondary engagement points 30 are distributed evenly and equally on their respective components, so that the primary and secondary engagement points line up with each other. As one of the locking rings rotates within a corresponding ear frame portion, the primary and secondary engagement points 30 become lined up and temporarily lock the orientation of the primary headband frame 1 in place. The angular lock should be temporary and able to be overcome by the user through applying sufficient angular force to the primary headband frame 1 or display support arms in order to impel the primary 70 and secondary engagement points 30 out of engagement with each other. The specific orientations available to the user at which to engage the angular locking mechanism may be determined by the specific placement and spacing of the primary 70 and secondary engagement points 30. For example, by radially spacing the primary 70 and secondary engagement points 30 at 30 degrees from each other, the user is afforded the ability to selectively engage the headband portion at increments of 30 degrees relative to the first display support arm 4 and second display support arm 5, and thus to any VR display 100 attached to the display support arms. Thus, one or more of the at least one primary engagement point 70 of the first locking ring 6 is configured to selectably engaged with at least one of the at least one secondary engagement point 30 of the first ear portion frame 2, and one or more of the at least one primary engagement point 70 of the second locking ring 7 is configured to selectably engaged with at least one of the at least one secondary engagement point 30 of the second ear portion frame 3. As previously mentioned, in some embodiments, each primary engagement point 70 is a protrusion, while each secondary engagement point 30 is a receptacle configured to receive one of the primary engagement points 70. Alternatively, in some embodiments, each primary engagement point 70 is a receptacle and each secondary engagement point 30 is a protrusion, while each primary engagement point 70 is configured to receive one of the secondary engagement points 30.

Further, in some embodiments, the first locking ring 6 and the second locking ring 7 each comprise an overmolded brake portion 71, as seen in FIG. 10. Preferably, the overmolded brake portion 71 is externally and peripherally distributed about the first locking ring 6 and the second locking ring 7. The overmolded brake portion 71 increases friction between the locking rings and the ear frame portions in order to further secure the locking rings and ear frame portions together with respect to each other in order to prevent the primary headband frame 1 from becoming dislodged from the position selected by the user. The overmolded brake portion 71 is preferably manufactured of a frictional material such as, but not limited to, rubber, silicone, or any other material appropriate to the aforementioned application.

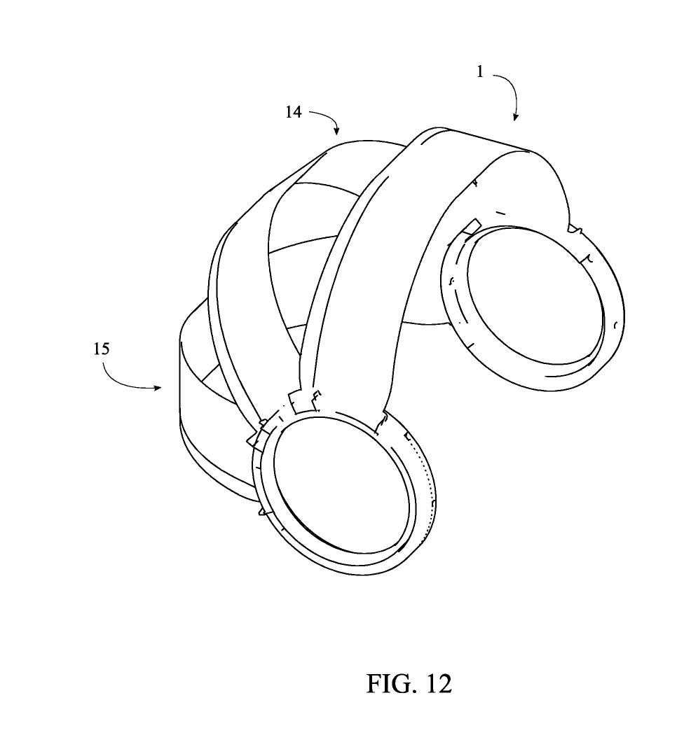

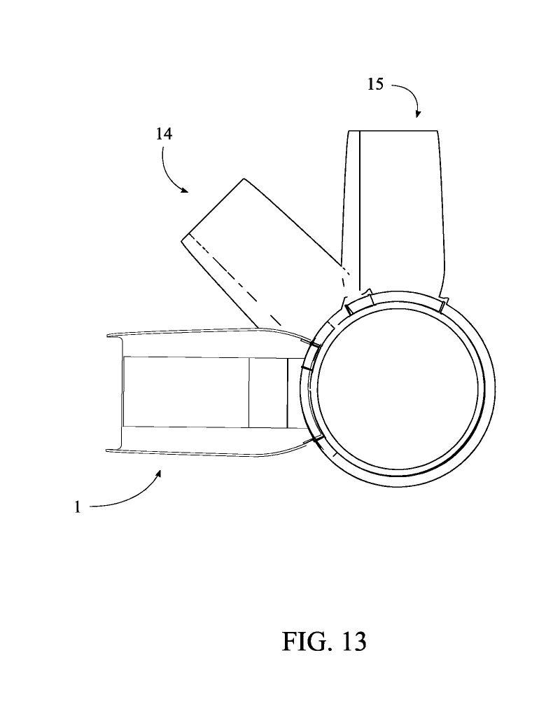

It is one intention of the present invention to address weight distribution of the present invention along with any attached VR display 100 and/or peripherals while worn on the user's head. To this end, some embodiments of the present invention may further comprise a secondary headband frame 14, as shown in FIG. 12-13. Similar to the primary headband frame 1, the secondary headband frame 14 is terminally attached between the first ear portion frame 2 and the second ear portion frame 3. In some embodiments, the secondary headband frame 14 is affixed in a stationary orientation relative to the primary headband frame 1 and/or display support arms. Preferably, however, in some embodiments the secondary headband frame 14 is rotatably engaged with the first ear portion frame 2 and the second ear portion frame 3. Depending on design considerations, in some embodiments the secondary headband frame 14 may alternatively be rotatably engaged with the first locking ring 6 and the second locking ring 7. Regardless, preferably the secondary headband frame 14 is configured to rotate independently relative to the primary headband frame 1. In some embodiments, the secondary headband frame 14 may be configured to be removably attached onto the first and second ear portion frames utilizing any desirable fastening mechanism. In some embodiments, the secondary headband frame 14 may be attached to the ear portion frames in a similar manner to the primary headband frame 1. In some embodiments, the secondary headband frame 14 may be configured to be removably attached to the first ear portion frame 2 and the second ear portion frame 3 through a snap fastener mechanism, simultaneously allowing removable attachment and rotation. The inclusion of the secondary headband frame 14 provides the user with an additional support component in order to properly distribute the weight of the present invention and any attached devices and peripherals on the user's head as desired. Further, in some embodiments the present invention may comprise a tertiary headband 15 configured in a similar manner to the secondary headband frame 14. Preferably, all headbands and/or headband frames are able to move independently of each other, and are constructed and configured so as to not interfere with each other's paths of rotation.

It may be noted that proper weight distribution may be achieved through various means. In general, the weight distribution of the present invention is considered in three locations: the headband, earpieces, and any attached display system. The weight may only distributed evenly from to back while wearing the product all together and rotating the headband either behind the neck at 180 degrees or behind the head at 135 degrees. Wearing at the top at 90 deg may cause the display to pull forward and or fall off, and extra headbands may be utilized to resolve this issue. Of further importance is that the balance is even from side to side and front to back. Various means may be utilized to accomplish this purpose that are not explicitly discussed in the current disclosure.

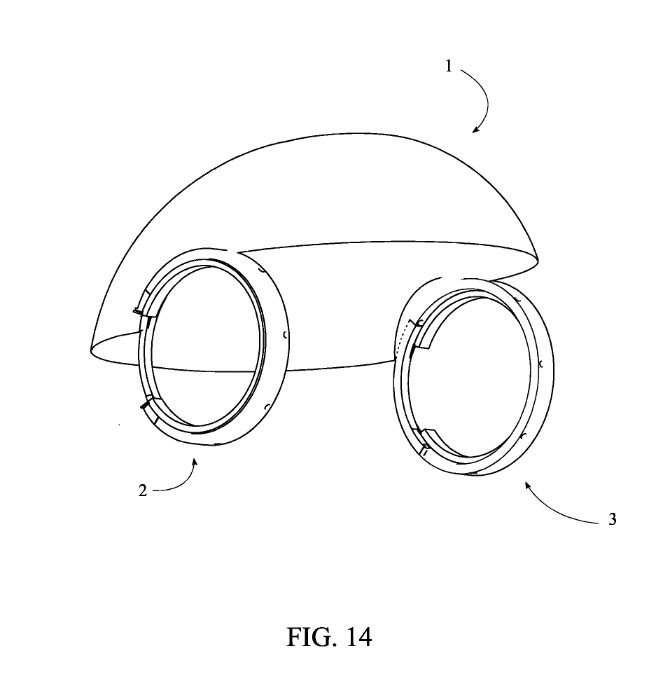

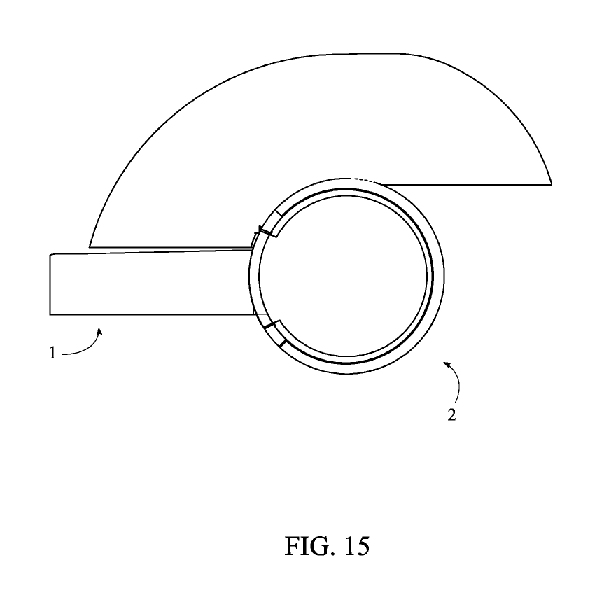

In one alternative embodiment, the strap or band-like nature of the primary headband frame 1 may be replaced with a helmet or ballcap-like configuration, as shown in FIG. 14. This configuration aids in weight distribution and balance while in use through greatly increased surface area contact with the user's head while in use. In another embodiment, the headband frame 1 may be used in conjunction with the helmet structure, as shown in FIG. 15.

Some embodiments of the present invention may further comprise a head movement tracking mechanism. The head movement tracking mechanism may be integrated into the present invention at any location in various embodiments. In some embodiments the head movement tracking mechanism may be located at the back of the user's head while in use. In such embodiments, the present invention may further comprise a tracking mechanism support which may be connected between the head movement tracking mechanism and either the headband frame, the first and second ear frame portions, or another location on the present invention. In some embodiments, the head movement tracking mechanism may be removably attached to the present invention through a hook and loop attachment interface.

Although the invention has been explained in relation to its preferred embodiment, it is to be understood that many other possible modifications and variations can be made without departing from the spirit and scope of the invention as hereinafter claimed.

What is claimed is:

1. A virtual reality (VR) headset frame comprises:
a primary headband frame;
a first ear portion frame and a second ear portion frame;
the first ear portion frame being terminally connected to the primary headband frame;
the second ear portion frame being terminally connected to the primary headband frame opposite the first ear portion frame along the primary headband frame;
the first ear portion frame, the second ear portion frame, and the primary headband frame being configured to receive a wireless audio headset;
a first display support arm;
a second display support arm;
the first display support arm being rotatably attached to the first ear portion frame;
the second display support arm being rotatably attached to the second ear portion frame;
the first display support arm and the second display support arm being configured to support a virtual reality (VR) display; and
the first display support arm and the second display support arm being configured to be selectably engaged into a plurality of orientations with respect to the primary headband frame.

2. The virtual reality headset frame as claimed in claim 1 comprises:
the primary headband frame comprises a first arced portion and a second arced portion;
the first arced portion and the second arced portion being oriented parallel to each other;
the first arced portion and the second arced portion being spaced apart from each other; and
the first arced portion and the second arced portion being terminally connected between the first ear portion frame and the second ear portion frame.

3. The virtual reality headset frame as claimed in claim 2 comprises:
the primary headband frame further comprises at least one crossmember;
each of the at least one crossmember being terminally connected between the first arced portion and the second arced portion; and
each of the at least one crossmember being positioned between the first ear portion frame and the second ear portion frame along the headband.

4. The virtual reality headset frame as claimed in claim 1 comprises:
the first display support arm and the second display support arm being configured to be selectably engaged into either a 90 degree orientation, a 135 degree orientation, or a 180 degree orientation with respect to the primary headband frame.

5. The virtual reality headset frame as claimed in claim 1 comprises:
the first display support arm and the second display support arm being configured to be selectably engaged into any orientation with respect to the primary headband frame.

6. The virtual reality headset frame as claimed in claim 1 comprises:
a first locking ring;
a second locking ring;
the first locking ring being rotatably attached within the first ear portion frame;
the second locking ring being rotatably attached within the second ear portion frame;
the first display support arm being terminally connected to the first locking ring; and
the second display support arm being terminally connected to the second locking ring.

7. The virtual reality headset frame as claimed in claim 6 comprises:
the first locking ring and the second locking ring each comprise at least one primary engagement point;
the first ear portion frame and the second ear portion frame each comprise at least one secondary engagement point;
each of the at least one primary engagement point being externally and peripherally distributed about the first locking ring and second locking ring;
each of the at least one secondary engagement point being internally distributed about the first ear portion frame and second ear portion frame,
wherein the at least one primary engagement point of the first locking ring is configured to be selectably engaged with the at least one secondary engagement point of the first ear portion frame, and
wherein the at least one primary engagement point of the second locking ring is configured to be selectably engaged with the at least one secondary engagement point of the second ear portion frame;

8. The virtual reality headset frame as claimed in claim 7 comprises:
each primary engagement point being a protrusion;
each secondary engagement point being a receptacle;
each secondary engagement point being configured to receive one of the primary engagement points;

9. The virtual reality headset frame as claimed in claim 6 comprises:
the first locking ring and the second locking ring each comprise an overmolded brake portion; and
the over molded brake portion being externally and peripherally distributed about the first locking ring and the second locking ring.

10. The virtual reality headset frame as claimed in claim 1 comprises:
a secondary headband frame; and
the secondary headband frame being terminally attached between the first ear portion frame and the second ear portion frame.

11. The virtual reality headset frame as claimed in claim 10 comprises:
the secondary headband frame being rotatably engaged with the first ear portion frame and the second ear portion frame; and
the secondary headband frame being configured to rotate independently relative to the primary headband frame.

12. The virtual reality headset frame as claimed in claim 10 comprises:
the secondary headband frame being rotatably engaged with the first locking ring and the second locking ring; and
the secondary headband frame being configured to rotate independently relative to the primary headband frame.
